(19) United States
(12) Patent Application Publication
(10) Pub. No.: US 2007/0298816 A1
(43) Pub. Date: Dec. 27, 2007

(54) Image storing apparatus and method for portable terminal

(75) Inventors: Se Youp Chu, Gumi-si (KR); Chang Taek Kang, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/702,216

(22) Filed: Feb. 5, 2007

(30) Foreign Application Priority Data
Jun. 27, 2006 (KR) 10-2006-0057974

(51) Int. Cl. H04Q 7/20

(52) U.S. Cl. 455/456.6

(57) ABSTRACT

An image storing system and method for a portable terminal is provided, wherein the image storing method includes identifying, in response to a store request of a photographed still or moving image, a country code of a country in which the portable terminal is currently located, setting a file naming scheme so as to generate default file names containing the identified country code for photographed images to be stored, and storing the requested still or moving image with a default file name generated according to the file naming scheme. The system includes a controller for identifying the current location of the portable terminal, assigning a default file name, which contains the country code associated with the identified location, to the photographed still or moving image, and controlling a memory unit to store the photographed still or moving image with the assigned default file name.

### CROSS-REFERENCE TO RELATED APPLICATION

This application claims the benefit under 35 U.S.C. §119(a) of Korean Patent Application No. 10-2006-0057974 filed Jun. 27, 2006 in the Korean Intellectual Property Office, the entire disclosure of which is hereby incorporated by reference.

### BACKGROUND OF THE INVENTION

1. Field of the Invention

The present invention relates generally to a portable terminal. More particularly, the present invention relates to an image storing system and method for a portable terminal, wherein file names of still and moving images stored in the portable terminal include information on the country of location at the time of photographing.

2. Description of the Related Art

Advanced portable terminals support not only conventional phone call processing but also various other functions related to, for example, MPEG audio layer 3 (MP3) players for listening to music, digital multimedia broadcasting (DMB) receivers for viewing multimedia broadcasts, and cameras for photographing still and moving images. In particular, the feature of photographing and storing still and moving images using a camera module is now considered an essential part of a modern portable terminal. Unlike a digital camera, a portable terminal includes an input unit comprised of a keypad, hence a user can freely assign mnemonic names to image files containing photographed still or moving images. However, when an image file is stored in a portable terminal, most of the time the user does not give a mnemonic name to the image file but simply uses a preset default naming scheme.

FIG. 2 is a flow chart illustrating steps of a conventional image storing method. Referring to FIG. 2, a portable terminal is initially in a preview mode awaiting a photograph command at step (S200). In response to a photograph command received through a keypad of the portable terminal, the portable terminal photographs a still or moving image of a target object at step (S210), and requests the user to decide whether to store the photographed still or moving image at step (S220). If the user decides to store the photographed still or moving image, the portable terminal assigns a default file name such as ‘photo001’ or ‘VOICE CAM001’, or a file name input by the user, to the still or moving image, and stores the still or moving image with the default or input name at step (S230).

FIGS. 3A and 3B illustrate display screen representations of image file names processed by the method of FIG. 2. FIG. 3A illustrates exemplary default file names, and FIG. 3B illustrates exemplary file names given by the user.

However, in the conventional method, when a plurality of still or moving images are successively photographed for storage, the user can have difficulty in inputting file names for the individual still or moving images to be stored. Further, when photographed still and moving images are stored with default file names, the user can have difficulty in distinguishing individual still or moving images by file names. In the case of a portable terminal that can be used in multiple countries through international roaming, when still and moving images photographed in multiple countries are stored with default file names, the user can still further have difficulty in subsequently identifying photograph information, such as the country in which a stored still or moving image was photographed.

Accordingly, a need exists for a system and method for providing file names of images captured and stored in a portable terminal which include advanced information, such as the country of photograph origination.

### SUMMARY OF THE INVENTION

Embodiments of the present invention have been made to substantially address the above and other problems, and an object of embodiments of the present invention is to provide an image storing method for a portable terminal, wherein a file name of a stored still or moving image includes a country code of a country of location at the time of photographing.

In accordance with an exemplary embodiment of the present invention, an image storing method for a portable terminal is provided, comprising identifying, in response to a store request of a photographed still or moving image, a country code of a country in which the portable terminal is currently located, setting a file naming scheme so as to generate default file names containing the identified country code for photographed images to be stored, and storing the requested still or moving image with a default file name generated according to the file naming scheme in the portable terminal.

In accordance with another exemplary embodiment of the present invention, an image storing method for a portable terminal is provided, comprising determining whether a change in country in which the portable terminal is located occurs, setting, if a change in country occurs, a file naming scheme so as to generate default file names containing a new country code for photographed images to be stored, and storing, in response to a store request of a photographed still or moving image, the photographed still or moving image with a default file name generated according to the file naming scheme in the portable terminal.

In accordance with another exemplary embodiment of the present invention, an image storing system of a portable terminal is provided, comprising a radio frequency (RF) unit for receiving signals containing information on a current location of the portable terminal, wherein the information can comprise a mobile country code (MCC) identifying a country, and a mobile network code (MNC) identifying a network operator, a memory unit for storing photographed still and moving images with default file names and storing one or more country code assignment tables to determine a country code associated with the country in which the portable terminal is located and a country code received from a corresponding base station, and a controller for identifying a current location of the portable terminal, assigning a default file name which contains a country code associated with the identified location to the photographed still or moving image, and controlling the memory unit to store the photographed still or moving image with the assigned default file name.

### BRIEF DESCRIPTION OF THE DRAWINGS

The above and other objects, features and advantages of embodiments of the present invention will become more apparent from the following detailed description in conjunction with the accompanying drawings, in which:

FIG. 1 is a block diagram illustrating an exemplary configuration of a portable terminal capable of using an image storing method in accordance with embodiments of the present invention;

FIG. 2 is a flow chart illustrating steps of a conventional image storing method;

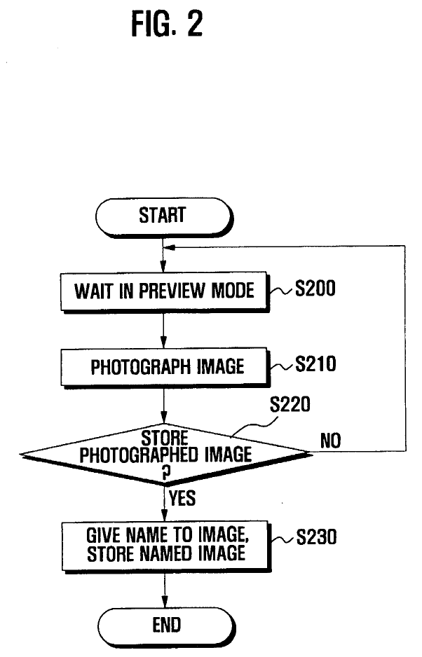

FIGS. 3A and 3B illustrate display screen representations of image file names processed by the method of FIG. 2;

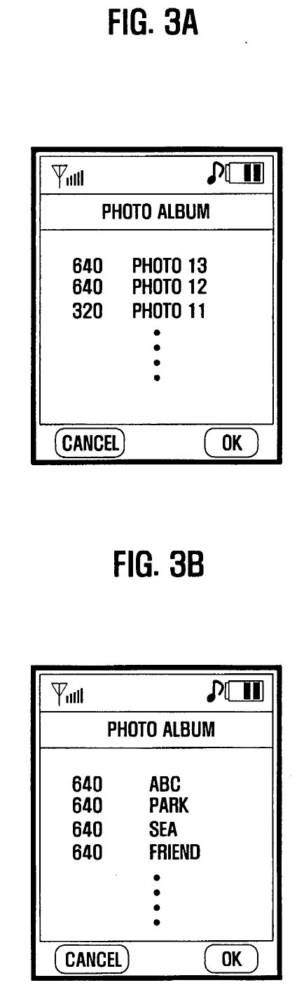

FIG. 4 is a flow chart illustrating steps of an image storing method for a portable terminal according to an exemplary embodiment of the present invention;

FIG. 5 is a flow chart illustrating steps of an image storing method for a portable terminal according to another exemplary embodiment of the present invention; and

FIGS. 6A and 6B illustrate display screen representations of image file names containing country codes processed by the method of FIG. 4 or 5.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described in detail with reference to the accompanying drawings. The same reference symbols identify the same or corresponding elements in the drawings. Constructions or processes well known to those skilled in the art may be not described to avoid obscuring the invention in unnecessary detail.

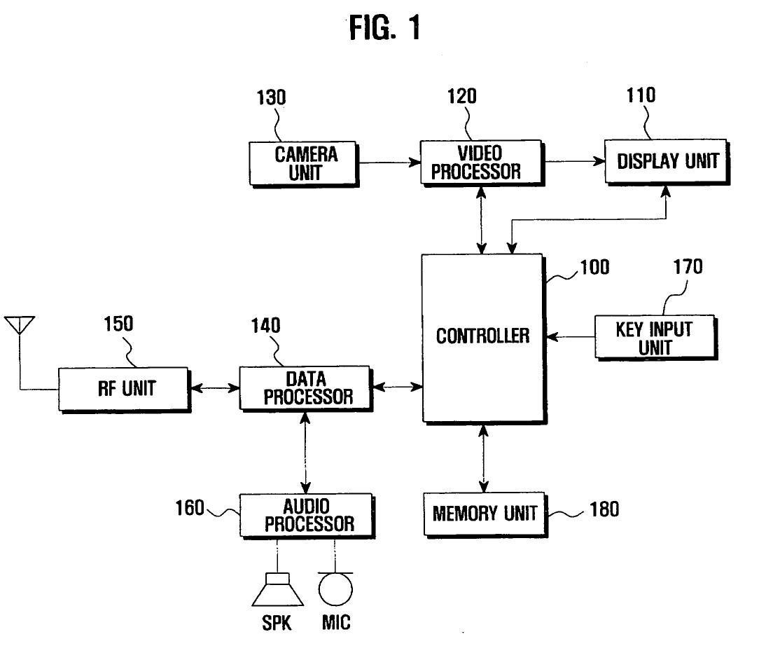

FIG. 1 illustrates an exemplary configuration of a portable terminal capable of using an image storing method in accordance with embodiments of the present invention.

Referring to FIG. 1, the portable terminal comprises a controller 100, a display unit 110, a video processor 120, a camera unit 130, a data processor 140, a radio frequency (RF) unit 150, an audio processor 160, a key input unit 170, and a memory unit 180.

The RF unit 150 can comprise an RF transmitter for upconverting the frequency of a signal to be transmitted and amplifying the signal, and an RF receiver for low-noise amplifying a received signal and downconverting the frequency of the signal. In an exemplary embodiment of the present invention, the RF unit 150 receives a signal containing information on the current location of the portable terminal. The location information can include at least one of a mobile country code (MCC) identifying a country, and a mobile network code (MNC) identifying a network operator.

The data processor 140 encodes and modulates signals to be transmitted through the RF unit 150, and demodulates and decodes signals received by the RF unit 150.

The audio processor 160 can include an encoder/decoder (codec). The codec can include a data codec for processing packet data, and an audio codec for processing audio signals such as a voice signal. The audio processor 160 converts a digital audio signal from the data processor 140 into an analog signal through the audio codec to reproduce the analog signal through a speaker SPK. The audio processor 160 also converts an analog audio signal from a microphone MIC into a digital audio signal through the audio codec to send the digital audio signal to the data processor 140. The codec can be implemented as a separate entity or as part of the controller 100.

The key input unit 170 can include numeric, character and/or function keys for inputting numeric and character information from the user and for setting various functions.

The memory unit 180 can include one or more program memory sections and data memory sections. The program memory section preferably stores control programs for controlling the overall operation of the portable terminal, and the data memory section preferably stores data resulting from the operation of the portable terminal. In an exemplary embodiment of the present invention, the memory unit 180 preferably stores photographed still and moving images with default file names. The memory unit 180 also preferably stores one or more country code assignment tables to determine a country code associated with the country in which the portable terminal is located, and a country code received from a corresponding base station.

The camera unit 130 can comprise a camera sensor for photographing image data and converting a photographed light signal into an electric signal, and a signal processor for converting an analog image signal photographed in the camera sensor into digital data. The camera sensor can be embodied as a charge-coupled device (CCD) sensor, and the signal processor can be embodied as a digital signal processor (DSP), but each are not limited thereto. The camera sensor and the signal processor can be embodied in an integral component or in separate components.

The video processor 120 generates screen data to thereby display a digital signal from the camera unit 130, and compresses and decompresses video data as directed.

The display unit 110 outputs various display information generated by the portable terminal. The display unit 110 can include a panel that is comprised of display devices such as liquid crystal display (LCD) devices or organic light emitting diodes (OLED). If the panel has a touch screen capability, the display unit 110 can also act as an input means for controlling the portable terminal together with or in place of the key input unit 170.

The controller 100 controls operations and operating modes of the portable terminal on the basis of signals input from the key input unit 170. In an exemplary embodiment of the present invention, when a still or moving image is photographed for storage, the controller 100 identifies the current location of the portable terminal, assigns a default file name, which contains a country code associated with the identified location, to the photographed still or moving image, and controls the memory unit 180 to store the photographed still or moving image with the assigned default file name.

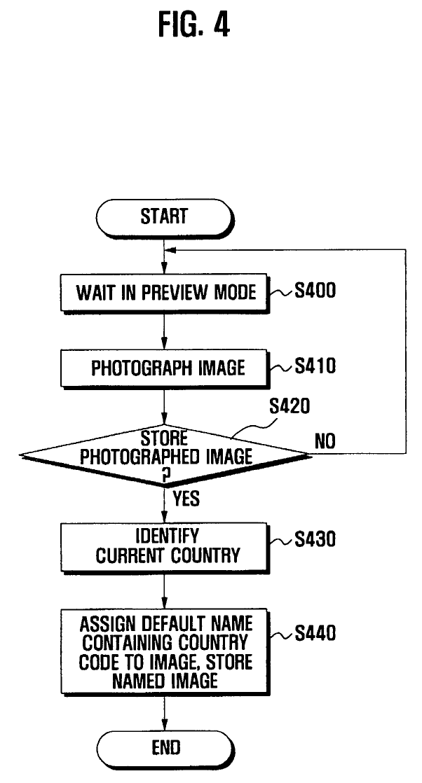

FIG. 4 is a flow chart illustrating steps of an image storing method for a portable terminal according to an exemplary embodiment of the present invention. Referring to FIGS. 1 and 4, the exemplary method is described below.

The portable terminal is initially in a preview mode awaiting a photograph command at step (S400). In response to a photograph command input through the key input unit 170, the portable terminal photographs a still or moving image of a target object at step (S410), and requests the user to decide whether to store the photographed still or moving image at step (S420). If the user decides not to store the photographed still or moving image, the portable terminal returns to step (S400) for previewing. If the user decides to store the photographed still or moving image, the portable terminal identifies a country code associated with its current location at step (S430).

To identify the country code at step (S430), the portable terminal preferably extracts an MCC/MNC value from a signal received from a corresponding base station, and finds a country code associated with the extracted MCC/MNC value in a country code assignment table stored in the portable terminal. For example, the following code segment “SEGMENT 1” shows a portion of an example country code assignment table for Europe.

### Segment 1

{0x0020201FUL, (INT8 *)“GR COSMOTE”, (INT8 *) “C-OTE”, DCS1800},
{0x0020205FUL, (INT8 *)“GR Panafon”, (INT8 *) “PAN”, GSM900},
{0x0020210FUL, (INT8 *)“GR Telestet”, (INT8 *) “TLSTET”, GSM900},
{0x0020404FUL, (INT8 *)“vodafone NL”, (INT8 *) “voda NL”, GSM900},
{0x0020408FUL, (INT8 *)“NL KPN”, (INT8 *) “KPN”, GSM900},
{0x0020412FUL, (INT8 *)“NL Telfort”, (INT8 *) “NL Telfort”, GSM900}

For example, if an extracted MCC/MNC value is 0x0020201, it can be determined from the example country code assignment table that the country in which the portable terminal is currently located is Greece, whose mobile country code is 202. It is to be understood that the controller 100 can also extract only part of the MCC/MNC, or extract a different type of country-indicating codes or data from a received signal. In addition, a GPS system can be provided in the portable terminal, and the controller can use GPS coordinates and, optionally, a position/country look-up table, and identify the country in which an image is captured using the portable terminal.

Thereafter, the portable terminal sets a file naming scheme so as to assign a default file name containing the identified country code to the still or moving image to be stored, and stores the still or moving image with the default file name at step (S440).

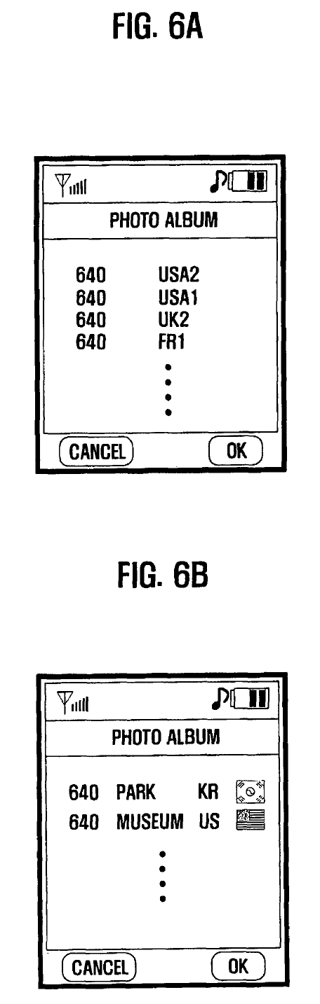

FIGS. 6A and 6B illustrate exemplary display screen representations of image file names containing country codes. FIG. 6A illustrates exemplary default file names containing country codes. The default file name of a stored still or moving image preferably comprises a combination of a country code and a sequence number. The country code is associated with the country in which the stored still or moving image was photographed, and the sequence number is assigned in the order of photographing.

FIG. 6B illustrates file names given by the user. When the user inputs a file name for a photographed still or moving image, the portable terminal can display at least one of a country code and a national flag next to the file name.

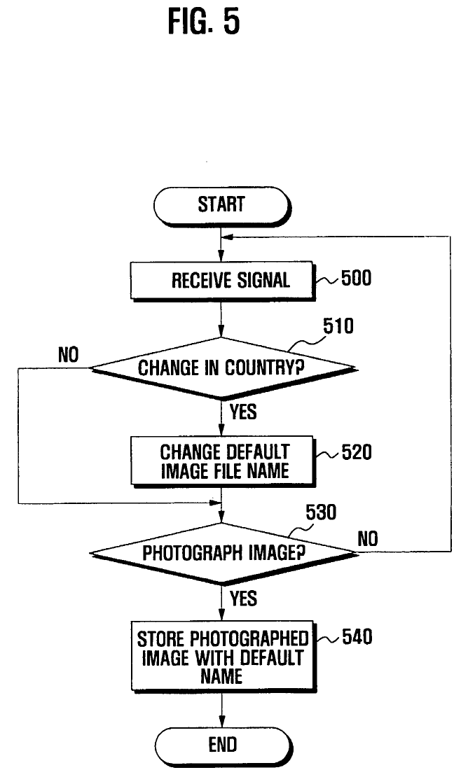

FIG. 5 is a flow chart illustrating steps of an image storing method for a portable terminal according to another exemplary embodiment of the present invention. Referring to FIGS. 1 and 5, the exemplary method is described below.

The portable terminal receives a signal from a corresponding base station at step (S500), and determines whether a change in country in which the portable terminal is located occurs at step (S510). At step (S510), the portable terminal preferably extracts an MCC/MNC value from the received signal, finds a country code associated with the extracted MCC/MNC value in a stored country code assignment table, and compares the found country code with a country code stored in the memory unit 180. If the found country code is different from the stored country code, the portable terminal determines that a change in country has occurred.

If a change in country occurs at step (S510), the portable terminal sets a file naming scheme so as to assign a default file name containing the found country code to a still or moving image to be stored, and updates the stored country code with the found country code at step (S520).

Thereafter, if the user issues a command to photograph and store a still or moving image through the key input unit 170 at step (S530), the portable terminal stores the photographed still or moving image with a default file name at step (S540).

As apparent from the above description, embodiments of the present invention provide an image storing system and method for a portable terminal, wherein a still or moving image is stored with a default file name containing a country code associated with a country in which the still or moving image is photographed. As a result, a user roaming through multiple countries can conveniently photograph and manage still and moving images.

While the method and apparatus for storing photographed images are provided in exemplary embodiments of the present invention, it will understood by those skilled in the art that various changes and modifications of the embodiments are possible. For example, in yet other embodiments of the present invention, rather than a photographed image, a downloaded or otherwise received image can be stored with a file name containing a country code.

Embodiments of the present invention can be realized in a number of ways, including computer-readable code written on computer-readable recording medium. The computer-readable recording medium can comprise any type of recording device in which data is stored in a computer-readable manner. Examples of the computer-readable recording medium include, but are not limited to, ROM, RAM, CD-ROM, magnetic tape, floppy disc, optical data storage, and carrier wave (e.g., data transmission through the Internet). The computer-readable recording medium can be distributed over a plurality of computer systems connected to a network so that computer-readable code is written thereto and executed therefrom in a decentralised manner. Further, functional programs, code, and code segments needed for realising embodiments of the present invention can be easily construed by one of ordinary skill in the art.

While exemplary embodiments of the present invention have been shown and described in this specification, it will be understood by those skilled in the art that various changes or modifications of the embodiments are possible without departing from the spirit and scope of the invention as defined by the appended claims and equivalents.

What is claimed is:

1. An image storing method for a portable terminal, comprising:
identifying, in response to a store request of a still or moving image, a country code of a country in which the portable terminal is currently located;
setting a file naming scheme so as to generate default file names containing the identified country code for images to be stored; and
storing the requested still or moving image with a default file name generated according to the file naming scheme in the portable terminal.

2. The image storing method of claim 1, wherein the identification of a country code comprises:
receiving a signal containing a mobile country code (MCC)/mobile network code (MNC) value from a corresponding base station and extracting the MCC/MNC value from the received signal; and
finding a country code associated with the extracted MCC/MNC value in a country code assignment table stored in the portable terminal.

3. An image storing method for a portable terminal, comprising:
determining whether a change in country in which the portable terminal is located occurs;
setting, if a change in country occurs, a file naming scheme so as to generate default file names containing a new country code for images to be stored; and
storing, in response to a store request of a still or moving image, the still or moving image with a default file name generated according to the file naming scheme in the portable terminal.

4. The image storing method of claim 3, wherein the determination of whether a change in country occurs comprises:
receiving a signal containing a mobile country code (MCC)/mobile network code (MNC) value from a corresponding base station and extracting the MCC/MNC value from the received signal;
finding a country code associated with the extracted MCC/MNC value in a country code assignment table stored in the portable terminal; and
comparing the found country code with a country code stored in the portable terminal.

5. The image storing method of claim 4, wherein the determination of whether a change in country occurs further comprises determining, if the found country code is different from a stored country code, that a change in country has occurred.

6. The image storing method of claim 5, wherein the determination of whether a change in country occurs further comprises updating, if a change in country occurs, the stored country code with the found country code.

7. The image storing method of claim 1, wherein the portable terminal is configured to display at least one of a country code and a national flag next to the file name.

8. The image storing method of claim 3, wherein the portable terminal is configured to display at least one of a country code and a national flag next to the file name.

9. An image storing apparatus for a portable terminal, comprising:
a radio frequency (RF) unit, for receiving signals containing information on a current location of the portable terminal, wherein the information can comprise a mobile country code (MCC) identifying a country, and a mobile network code (MNC) identifying a network operator;
a memory unit for storing still and moving images with default file names and storing one or more country code assignment tables to determine a country code associated with the country in which the portable terminal is located, and a country code received from a corresponding base station; and
a controller for identifying a current location of the portable terminal, assigning a default file name, which comprises a country code associated with the identified location, to the still or moving image, and controlling the memory unit to store the still or moving image with the assigned default file name.

10. The image storing apparatus of claim 9, further comprising a camera unit for photographing still and moving images.

11. The image storing apparatus of claim 9, further comprising a means for downloading still and moving images to the portable terminal.

12. The image storing apparatus of claim 9, further comprising a display unit for outputting display information generated by the portable terminal, wherein the portable terminal is configured to display at least one of a country code and a national flag next to the file name.
